(19) United States
(12) Patent Application Publication
(10) Pub. No.: US 2020/0270540 A1
(43) Pub. Date: Aug. 27, 2020

(54) Method for Producing an Odor-Free HTC Coal and Odor-Free HTC Coal

(71) Applicant: TerraNova Energy GmbH, Düsseldorf (DE)

(72) Inventor: Marc Buttmann, Düsseldorf (DE)

(21) Appl. No.: 16/753,704

(22) PCT Filed: Oct. 2, 2018
(86) PCT No.: PCT/EP2018/076803

§ 371 Date: Apr. 3, 2020

(30) Foreign Application Priority Data
Oct. 6, 2017 (DE) 10 2017 123 281.8

(51) Int. Cl. C10L 9/08; C10L 5/46; C05F 7/00

(52) U.S. Cl. CPC C10L 9/086; C10L 5/46; C05F 7/00; C10L 2290/08; C10L 2290/02; C10L 2200/0295; C10L 2200/0469; C10L 2230/18

(57) ABSTRACT

A method for producing an odor-free HTC coal, at least comprising the following steps: a) providing a biomass; b) performing a hydrothermal carbonization in order to produce a carbon sludge, the carbon sludge comprising HTC coal and HTC process water; c) separating HTC coal and HTC process water by a mechanical dewatering process; d) heating the HTC coal to a temperature of at least 150 degrees Celsius in order to remove highly volatile carbon compounds.

The present invention relates to a process for producing an odorless HTC carbon and to odorless HTC carbon. HTC carbon is a product of a hydrothermal carbonization of biomass, for example of sewage sludge.

Hydrothermal carbonization (HTC) converts biomass to a carbon sludge with exclusion of air, at temperatures between 170° C. and 250° C. [degrees Celsius] within a few hours. The prior art is described, for example, by DE 10 2007 062 808, DE 10 2007 062 809, DE 10 2007 062 810, DE 10 2007 062 811, DE 10 2007 056 170, DE 10 2008 058 444. These documents elucidate the hydrothermal carbonization of various kinds of biomass under different reaction conditions and in different processes.

In the last few years, the use of hydrothermal carbonization has concentrated on the processing of sewage sludge. Sewage sludge is a waste material from wastewater treatment that has to be disposed of at the expense of the sewage treatment works. What is particularly advantageous here is the high degree of dewatering of up to 70% of dry matter content that can be achieved in the sewage sludge after the treatment by HTC, since this distinctly reduces the residual amount to be disposed of and saves disposal costs.

It is known that HTC carbon is also suitable as fertilizer and can be applied to fields. However, owing to the content of volatile hydrocarbon compounds, HTC carbon is very odorous.

It is further known that the HTC carbon and HTC process water products obtained after an HTC process, present collectively as carbon sludge, can be separated from one another by a mechanical dewatering operation, for example with a belt press, a chamber filter press or a centrifuge. Also known is the subsequent drying of the HTC carbon to improve storability etc.

There is a constant search for new possible uses for further use of HTC carbon.

It is an object of the present invention to at least partly solve the problems outlined with reference to the prior art, and more particularly to provide a process for preparing an essentially odorless HTC carbon. In addition, an odorless HTC carbon is to be proposed.

The object is achieved by the features of independent claims 1 and 8. Advantageous developments are the subject of the dependent claims. The features (also) listed individually in the (independent) claims are combinable with one another in a technologically viable manner and can be supplemented with explanatory matter from the description and details from the figures, wherein further embodiments of the invention are shown.

A process for producing an (essentially odorless) HTC carbon is proposed, at least comprising the following steps:
a) providing a biomass, especially sewage sludge;
b) performing a hydrothermal carbonization to produce a carbon sludge; where said carbon sludge comprises HTC carbon and HTC process water;
c) separating HTC carbon and HTC process water by a mechanical dewatering operation;
d) heating the HTC carbon for removal of volatile carbon compounds to a temperature of at least 150 degrees Celsius.

Steps a) to c) are known from the prior art. Also known is drying of the HTC carbon, i.e. removal of water from the HTC carbon, for example to improve storability. However, the temperatures used here to date have regularly been just above 100 degrees Celsius (at most 110 degrees Celsius). What was avoided in this way was in particular that other organic compounds were driven out of the HTC carbon by elevated temperatures.

What is now proposed in the present context is to treat the HTC carbon at higher temperatures for a predeterminable period of time. The effect of the higher temperatures of more than 150 degrees Celsius, especially at least 175 degrees Celsius, preferably at least 200 degrees Celsius, is that not only the water but also volatile hydrocarbon compounds can be very substantially removed from the HTC carbon. These volatile hydrocarbon compounds are responsible for the perceptible strong odor of the HTC carbon.

More particularly, the HTC carbon (completely or at least to an extent of 95% by weight, preferably to an extent of at least 99% by weight) is heated to a temperature of more than 150 degrees Celsius, especially more than 180 degrees Celsius, preferably more than 200 degrees Celsius.

Removal of these volatile hydrocarbon compounds enables the provision of a (largely) odorless HTC carbon that is thus suitable for other end uses. More particularly, it is thus possible to use the HTC carbon as an odorless fertilizer or as a ground cover material. This fertilizer or ground cover material could especially be used in relatively highly populated areas, for example even in urban areas.

The use of the HTC carbon as ground cover material, for example as what is called a mulch, enables the replacement of materials used to date such as bark mulch, sawdust, green waste, etc. This continues to achieve the advantages achievable by the known mulching, such as protection of the soil or of the humus layer or potting soil present beneath the mulch, input of nutrients through successive composting of the HTC carbon, and the prevention of weeds through the reduced incidence of light on the soil. However, the HTC carbon can additionally be provided in predeterminable shape, for example as a result of pelletization, and size, in which case it is possible to improve the application of the mulch (the ground cover material or else the fertilizer) by man or machine. It is further possible to color the HTC carbon, such that any requirements that exist (for example from an esthetic point of view or in relation to the absorption of heat) can be fulfilled with regard to these properties too.

The mulching of soil prevents wind from drying out the soil or the water from evaporating, inter alia. Rain in turn is absorbed by the soil and does not wash it away owing to the covering with mulch. The mulch protection layer additionally acts like a warming blanket and can thus accelerate the growth of the plants.

The covering of soil with mulch can thus simplify the layout and planting of green areas. The use of odorless HTC carbon now also enables use in urban areas.

The heating in step d) is especially effected in such a way that more than 3% by weight, especially at least 5% by weight, of the dry matter is volatilized.

The dry matter (dry residue) is ascertained in a known manner according to DIN EN 12880. For this purpose, a material is placed on a balance and heated at 105 degrees Celsius until no weight loss is detectable any longer. The (dry) material (the dry matter) now present no longer includes any water.

What is proposed in the present context is to treat the HTC carbon at relatively high temperatures until at least 3% by weight of the dry matter has been volatilized. The thermal treatment required (temperature and time) can be predetermined on samples.

The weight loss of the dry matter proposed here is the measurable parameter for determining that the volatile hydrocarbons have been removed from the HTC carbon. Experiments have shown that a (largely) odor-neutral HTC carbon is present thereafter.

More particularly, in step d), not more than 18% by weight, preferably not more than 12% by weight, preferably not more than 7% by weight, of the dry matter is volatilized.

More particularly, step d) is effected at a temperature of not more than 350 degrees Celsius, preferably of not more than 300 degrees Celsius, more preferably of not more than 250 degrees Celsius.

Step d) is especially conducted at ambient pressure (i.e. of about 1 bar) and without protective gas (i.e. specifically no exclusion of air but under ambient air).

It is of course possible to collect the volatile hydrocarbons removed from the HTC carbon in step d) and utilize them further.

Step b) (i.e. the hydrothermal carbonization) can be performed in a known manner at a temperature between 170 to 250 degrees Celsius, with exclusion of air and at a pressure of 5 to 40 megapascals.

More particularly, after step d), coloring of the HTC carbon can be conducted. The coloring is effected with regard to the later use of the HTC carbon. More particularly, it is thus possible to influence the propensity to absorb thermal energy. The coloring results in a change in the color of the HTC carbon.

Moreover, before, during or preferably after step d), the HTC carbon can be shaped. The HTC carbon can thus be provided in a predeterminable shape and size.

What is further proposed is an HTC carbon, especially prepared by the process described above, wherein the HTC carbon at an ambient pressure (i.e. of about 1 bar) and 20 degrees Celsius is (largely or substantially) odorless with respect to volatile carbon compounds.

The remarks relating to the method described above are equally applicable to the HTC carbon and vice versa.

More particularly, the HTC carbon (owing to coloring) has a color atypical of HTC carbon.

What is further proposed is the use of an above-described HTC carbon as ground cover material or fertilizer.

The remarks relating to the process described above are equally applicable to the use of the HTC carbon and vice versa.

The invention and the technical field are elucidated in detail hereinafter with reference to the figure. The figure shows a particularly preferred embodiment, but the invention is not limited thereto. More particularly, it should be pointed out that the figure and especially the size ratios shown are merely schematic. Identical reference numerals relate to identical articles.

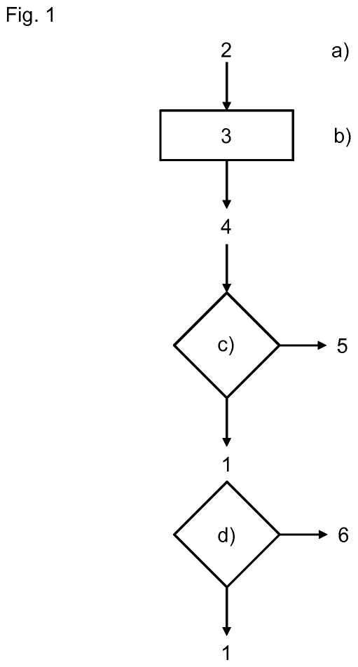

FIG. 1 shows the sequence of a process for preparing an odorless HTC carbon 1.

In step a), a biomass 2 is provided. In step b), a hydrothermal carbonization 3 for production of a carbon sludge 4 is conducted. The carbon sludge 4 comprises an HTC carbon 1 and an HTC process water 5. In the subsequent step c), HTC carbon 1 and HTC process water 5 are separated from one another by a mechanical dewatering operation. In step d), the HTC carbon 1 is heated to a temperature of at least 150 degrees Celsius for removal of volatile carbon compounds 6. In this step, more than 3% by weight of the dry matter of HTC carbon 1 is volatilized.

### LIST OF REFERENCE NUMERALS

1 HTC carbon
2 biomass
3 hydrothermal carbonization
4 carbon sludge
5 HTC process water
6 volatile carbon compounds

1. A process for producing an HTC carbon, at least comprising the following steps:
a) providing a biomass;
b) performing a hydrothermal carbonization to produce a carbon sludge; where said carbon sludge comprises HTC carbon and HTC process water;
c) separating HTC carbon and HTC process water by a mechanical dewatering operation;
d) heating the HTC carbon for removal of volatile carbon compounds to a temperature of at least 150 degrees Celsius.

2. The process as claimed in claim 1, wherein more than 3% by weight of the dry matter is volatilized in step d).

3. The process as claimed in claim 1, wherein not more than 18% by weight of the dry matter is volatilized in step d).

4. The process as claimed in claim 1, wherein step d) is effected at a temperature of not more than 350 degrees Celsius.

5. The process as claimed in claim 1, wherein step d) is performed at an ambient pressure and without protective gas.

6. The process as claimed in claim 1, wherein step b) is performed at a temperature between 170 to 250 degrees Celsius, with exclusion of air and at a pressure of 5 to 40 megapascals.

7. The process as claimed in claim 1, wherein step d) is followed by coloring of the HTC carbon.

8. An HTC carbon, wherein the HTC carbon at an ambient pressure and 20 degrees Celsius is odorless with respect to volatile carbon compounds.

9. The HTC carbon as claimed in claim 8, wherein the HTC carbon has a color atypical of HTC carbon.

10. A use of an HTC carbon as claimed in claim 8 as ground cover material or fertilizer.
